(19) United States
(12) Patent Application Publication
(10) Pub. No.: US 2026/0003787 A1
(43) Pub. Date: Jan. 1, 2026

(54) Asymmetrical Last Level Cache

(71) Applicant: Advanced Micro Devices, Inc., Santa Clara, CA (US)

(72) Inventor: Mahesh Subramony, Austin, TX (US)

(73) Assignee: Advanced Micro Devices, Inc., Santa Clara, CA (US)

(21) Appl. No.: 18/757,238

(22) Filed: Jun. 27, 2024

(51) Int. Cl. G06F 12/0811; G06F 9/38; G06F 13/18

(52) U.S. Cl. CPC G06F 12/0811; G06F 9/3836; G06F 13/18

(57) ABSTRACT

An asymmetrical last level cache is described. In one or more implementations, a system includes a first set of cores with an associated first last level cache and a second set of cores with an associated second last level cache. The first and second last level caches are asymmetrical, meaning they have differing characteristics such as size, speed, replacement policy, or associativity. This configuration allows for dynamic allocation of tasks to the cores based on a combination of the performance characteristics of the cores and the attributes of their associated last level caches.

### BACKGROUND

In contemporary computing systems, the management of cache memory is a cornerstone of achieving high performance and energy efficiency. Cache memory serves as a high-speed intermediary between the processor and main memory, storing frequently accessed data to reduce latency and improve processing speed. As computing demands have diversified, the challenge of optimizing cache memory to meet the varying requirements of different applications has become increasingly complex.

### BRIEF DESCRIPTION OF THE DRAWINGS

FIG. 1 is a block diagram of a non-limiting example system having an asymmetrical last level cache to service a heterogeneous core architecture.

FIG. 2 is a block diagram of a non-limiting example in which instructions are scheduled to cores based on differing characteristics of cores and caches across both a heterogeneous core architecture and asymmetrical last level cache.

FIG. 3 is a block diagram of a non-limiting example that includes a cache hierarchy with asymmetrical last level cache.

FIG. 4 depicts a non-limiting example procedure for asymmetrical last level caches.

FIG. 5 is a block diagram of a processing system configured to execute one or more applications, in accordance with one or more implementations.

### DETAILED DESCRIPTION

An asymmetrical last level cache is described. In accordance with the described techniques, an asymmetrical last level cache is utilized in a system having a “heterogeneous architecture”. As described herein, a heterogeneous architecture refers to a system that uses multiple types of processors or cores. Typically, instructions are assigned to the most suitable processor type to optimize performance and energy efficiency. By using the best-suited processor for each task, heterogeneous architectures can achieve higher performance and lower power consumption compared to homogeneous systems.

For example, a system having a heterogeneous architecture may include a set of “high-performance cores” and a set of “efficiency cores”. As described herein, high-performance cores are configured to execute instructions at a higher frequency than other types of cores. In order to execute instructions at such a higher frequency, however, performance cores may consume more power than other types of cores. Performance cores may be ideally suited to execute instructions for tasks where low latency is preferred. In contrast to performance cores, efficiency cores are configured to execute instructions at a lower frequency and thus may consume less power. The inclusion of different core types in a system is beneficial because it enables the system to take advantage of the characteristics of the different core types for heterogenous workloads.

Conventional cache architectures often adopt a uniform approach, providing similar cache resources to all cores regardless of their specific performance characteristics or the nature of the tasks they handle. This can lead to inefficiencies in both performance and power consumption, as the one-size-fits-all cache configuration may not align with the nuanced demands of modern heterogeneous computing environments.

In contrast to conventional architectures, the described system having a heterogeneous architecture also includes an asymmetrical last level cache. Typically, with conventional architectures, different sets of cores share a single last level cache or the different sets of cores are each associated with or coupled to separate, but symmetrical, last level caches. In such conventional architectures, though, a first last level cache and a second last level cache are substantially the same—they have substantially a same size (in terms of amount of storage) and/or utilize a same cache replacement policy, for instance.

Rather than a shared last level cache or symmetrical last level caches, the described system having a heterogeneous architecture includes at least a first last level cache and a second last level cache which is asymmetrical from the first last level cache. By “asymmetrical,” it is meant that the first last level cache has one or more different characteristics from the second last level cache. Examples of different characteristics of the last level caches include but are not limited to, cache size (e.g., storage capacity), cache speed, cache replacement policy, and associativity, to name just a few.

The described system is configured to take advantage of the differences between the first last level cache and the second last level cache when scheduling instructions. To do so, the first last level cache and the second last level cache are communicably coupled to a respective set of cores. For example, the first last level cache is coupled to a first set of cores and the second last level cache is coupled to a second set of cores. Unlike conventional systems, the system is capable of scheduling instructions to the cores of the first set of cores and the cores of the second set of cores based on both the heterogeneity of the core types and also the different characteristics between the first last level cache and the second last level cache.

In one or more implementations, the first set of cores includes a plurality of performance cores and the second set of cores includes a plurality of efficiency cores. In this example, the first last level cache to which the first set of cores is coupled is larger (e.g., has more storage capacity) than the second last level cache to which the second set of cores is coupled. The asymmetrical last level cache configuration provides several advantages that are particularly beneficial in a heterogeneous computing environment. The larger first last level cache, associated with the performance cores, is designed to accommodate the high data throughput and rapid access requirements that are characteristic of tasks demanding high computational power. This larger cache can store a greater amount of data, which is advantageous for performance-intensive applications that benefit from quick access to large datasets or complex algorithms that require substantial memory access.

On the other hand, the smaller second last level cache, associated with the efficiency cores, reflects the different usage patterns and requirements of these cores. Efficiency cores are typically used for less demanding tasks that do not require the same level of data throughput as performance cores. Consequently, a smaller cache is often sufficient for the workloads handled by efficiency cores, which tend to be more predictable and less data-intensive. This smaller cache size helps to conserve power, as maintaining a large cache consumes more energy, both in terms of the power to store data and the power to search through a larger dataset.

By optimizing the cache size for each type of core, the system can achieve a balance between performance and energy efficiency. This is particularly advantageous in mobile and embedded devices, where power consumption is a concern. The asymmetrical cache design allows such devices to deliver high performance when it is demanded by the user or application, while also conserving energy during less intensive operations, thereby extending battery life and reducing thermal output.

Thus, the asymmetrical last level cache architecture provides several advantages over conventional systems. For instance, the asymmetrical cache configuration allows for more efficient utilization of cache resources by tailoring the cache characteristics to the specific requirements of different core types within a heterogeneous system. This can lead to improved system performance, as high-performance cores can benefit from larger or faster caches that can keep pace with their higher processing speeds, while efficiency cores can be paired with smaller caches that are adequate for their lower performance requirements, thereby conserving power. Additionally, the asymmetrical cache design can contribute to reduced power consumption overall. By optimizing the cache size and performance for each core type, the system can minimize unnecessary power usage that would otherwise result from over-provisioning cache resources to cores that do not require them. Additionally, the disclosed system can provide enhanced flexibility in scheduling and executing instructions. The system can make more informed decisions by considering the characteristics of both the cores and their associated caches, leading to better workload distribution and potentially reducing bottlenecks that could occur when multiple cores compete for the same cache resources. Additionally, the asymmetrical cache configuration can improve the system's ability to handle a wide range of applications and workloads. By having caches that are specialized for different types of cores, the system can more effectively manage diverse tasks ranging from high-intensity computing to energy-efficient processing, making it well-suited for devices that require a balance between performance and power efficiency.

In some aspects, the techniques described herein relate to a computing device including: a first set of cores, a first last level cache associated with the first set of cores, a second set of cores, and a second last level cache associated with the second set of cores.

In some aspects, the techniques described herein relate to a computing device, wherein the first last level cache and the second last level cache are asymmetrical.

In some aspects, the techniques described herein relate to a computing device, wherein the first set of cores include a first core type and the second set of cores include a second core type.

In some aspects, the techniques described herein relate to a computing device, wherein the first set of cores of the first core type have at least one performance characteristic that is different than the second set of cores of the second core type.

In some aspects, the techniques described herein relate to a computing device, wherein the first set of cores of the first core type include high performance cores and the second set of cores of the second core type include efficiency cores.

In some aspects, the techniques described herein relate to a computing device, wherein the first last level cache is larger than the second last level cache.

In some aspects, the techniques described herein relate to a computing device, further including an operating system and a memory controller, the memory controller configured to assign instructions requested by the operating system to either the first set of cores associated with the first last level cache or the second set of cores associated with the second last level cache.

In some aspects, the techniques described herein relate to a computing device, wherein the memory controller is configured to assign instructions based on both performance characteristics of the first set of cores and the second set of cores and sizes of the first last level cache and the second last level cache.

In some aspects, the techniques described herein relate to a computing device, wherein the computing device includes a laptop, and wherein the first set of cores and the second set of cores are included in a central processing unit of the laptop.

In some aspects, the techniques described herein relate to a system including: a central processing unit, and at least two asymmetrical last level caches.

In some aspects, the techniques described herein relate to a system, wherein the central processing unit includes at least a first core and a second core.

In some aspects, the techniques described herein relate to a system, wherein the first core includes a high performance core and the second core includes an efficiency core.

In some aspects, the techniques described herein relate to a system, wherein the cache includes at least a first last level cache and a second last level cache.

In some aspects, the techniques described herein relate to a system, wherein the first last level cache is associated with the high performance core and the second last level cache is associated with the efficiency core.

In some aspects, the techniques described herein relate to a system, wherein the first last level cache is larger than the second last level cache.

In some aspects, the techniques described herein relate to a system, wherein the asymmetrical cache includes at least a third last level cache.

In some aspects, the techniques described herein relate to a system, further including a third core that is associated with the third last level cache.

In some aspects, the techniques described herein relate to a system, wherein the third core includes a low priority core.

In some aspects, the techniques described herein relate to a method including: scheduling a first instruction for execution on a first core of a first set of cores based on characteristics of cores of the first set of cores and based on characteristics of a first last level cache associated with the first set of cores, and scheduling a second instruction for execution on a second core of a second set of cores based on characteristics of cores of the second set of cores and based on characteristics of a second last level cache associated with the second set of cores.

In some aspects, the techniques described herein relate to a method, wherein the first core includes a high performance core and the second core includes an efficiency core, and wherein the first last level cache is larger than the second last level cache.

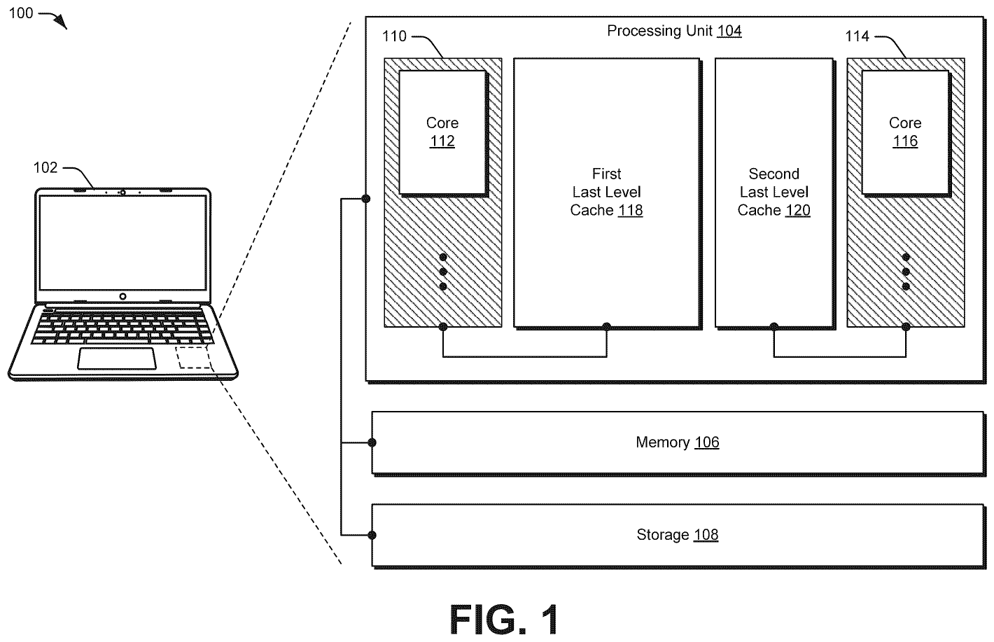

FIG. 1 is a block diagram of a non-limiting example system 100 having an asymmetrical last level cache to service a heterogeneous core architecture.

The system 100 with the heterogenous architecture and the asymmetrical last level cache is implemented at one or more computing devices, such as computing device 102. In one or more implementations, the system 100 includes one or more of a processing unit 104, memory 106, and storage 108.

In accordance with the described techniques, the processing unit 104 includes at least a first set of cores 110 having at least one core 112 (e.g., a first type of core) and a second set of cores 114 also having at least one core 116 (e.g., a second type of core). To implement a heterogenous architecture, different types of cores and/or cores having different characteristics are incorporated in an architecture, e.g., included in the processing unit 104. In the context of the illustrated example, for instance, the core 112 is a different core type from the core 116. In other words, the at least one core 112 has one or more different characteristics from the at least one core 116. As used herein, the term “set of cores” means one or more cores. Thus, the first set of cores 110 includes one or more cores, including at least the core 112. Similarly, the second set of cores 114 includes one or more cores, including at least the core 116. In at least one variation, the processing unit 104 includes more than two sets of cores, e.g., the processing unit 104 includes at least three different types of cores and thus three sets of cores.

One example core type is a performance core or “high-performance core,” which executes instructions at a higher frequency (e.g., executes more instructions in a given interval of time) than other types of cores. In order to execute instructions at such a higher frequency, however, performance cores may consume more power than other types of cores, e.g., cores that execute instructions at a lower frequency. Performance cores may be ideally suited to execute instructions for tasks where low latency (or speed) is preferred, such as in connection with productivity tasks (e.g., spreadsheets), securities trading, physics engines for gaming applications, and so on. Another example core type is an efficiency core. As used herein, an “efficiency core” refers to a core that executes instructions at a lower frequency (e.g., executes fewer instructions in the given interval of time) than other types of cores. By executing instructions at a lower frequency, efficiency cores may consume less power than other types of cores, e.g., cores that execute instructions at a higher frequency. Efficiency cores may be ideally suited to execute instructions for tasks where more latency is acceptable, such as for graphics (e.g., displaying video during a video conference “call”) and for artificial intelligence applications (e.g., training and/or inference). In addition to operating at higher or lower frequencies and consuming more or less power, a particular core type can have one or more other characteristics which distinguish it from other core types. For instance, one or more cores of the system 100 or a set of cores can be low priority cores, e.g., in a third set of cores.

The inclusion of different core types in the architecture is beneficial because it enables the system 100 to take advantage of the characteristics of the different core types for heterogenous workloads. Consider an example in which a user of the computing device 102 utilizes a video conferencing application (e.g., to conduct a video conference) while simultaneously utilizing a spreadsheet application (e.g., to model some financial situation). The workload is heterogenous because the different tasks are associated with different characteristics or “expectations.” For instance, users expect productivity tools (and thus tasks) to respond instantaneously or near instantaneously to user input, whereas users do not expect tasks such as video display to be output at a greater frame rate than the human eye is capable of perceiving. With reference to the continuing example, the system 100 is capable of directing instructions of the video conferencing application, for displaying video of a video conference, to one or more efficiency cores (e.g., the second set of cores 114). The system 100 is also capable of directing instructions of the spreadsheet application, for modeling a financial situation, to one or more performance cores (e.g., the first set of cores 110) for execution simultaneously. The system 100 is capable directing instructions of various tasks to the different core types to take advantage of the heterogeneous architecture in numerous ways.

In contrast to conventional architectures, the system 100 includes an asymmetrical last level cache. Typically, with conventional architectures, different sets of cores share a single last level cache or the different sets of cores are each associated with or coupled to separate, but symmetrical last level caches. In conventional architectures, for instance, a first set of cores is coupled to a first last level cache and a second set of cores is coupled to a second last level cache. In such conventional architectures, though, the first last level cache and the second last level cache are substantially the same—they have substantially a same size (in terms of amount of storage) and/or utilize a same cache replacement policy, for instance.

This is related to the way conventional systems handle the reporting of available cache and cache size, such as to an operating system. With conventional systems, an operating system (e.g., responsive to a request from an application) causes a request to be submitted to a single core. The single core responds by reporting the amount of cache available to the single core, which corresponds to the total cache of the conventional system divided by the number of cores. A hardware unit (e.g., of the corresponding processing unit) or the operating system then multiples the amount of cache reported from the single core by the number of cores of the system. This results in determining and thus outputting a substantially accurate amount of available cache or cache size, because the conventional systems equally share the entire last level cache and/or there are symmetrical last level caching resources for the cores. Because the described system 100 includes an asymmetrical last level cache to support the heterogenous architecture, using the same manner of determining and reporting cache as conventional techniques is not possible with the described technique. Each core of the system 100 does not have the same caching resources available as each other core of the system 100.

Rather than a shared last level cache or symmetrical last level caches, the system 100 includes a first last level cache 118 which is asymmetrical from a second last level cache 120. By “asymmetrical,” it is meant that the first last level cache 118 has one or more different characteristics from the second last level cache 120. Examples of different characteristics of the last level caches include but are not limited to, cache size (e.g., storage capacity), cache speed, cache placement policy, cache replacement policy, and associativity, to name just a few. In at least one example, the first last level cache 118 is larger than the second last level cache 120, e.g., the first last level cache 118 has more storage capacity than the second last level cache 120.

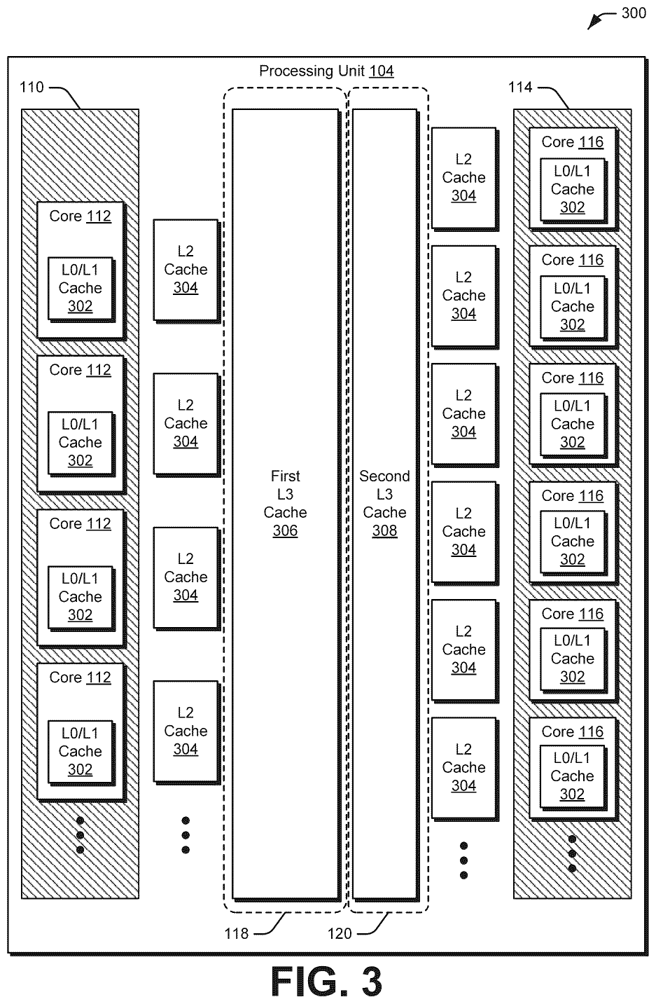

In one or more implementations, the first last level cache 118 and the second last level cache 120 correspond to last level caches of a cache hierarchy having multiple levels of cache, e.g., at least two levels. As discussed in more detail in relation to FIG. 3, for instance, the first last level cache 118 and the second last level cache 120 are separate L3 caches in a cache hierarchy that includes L0 and/or L1 caches (e.g., included in each core of the first set of cores 110 and each core of the second set of cores 114) and L2 caches (e.g., communicably coupled to each core of the first set of cores 110 and each core of the second set of cores 114).

In addition to taking advantage of the heterogeneous architecture in terms of cores, in contrast to conventional approaches, the system 100 is also configured to take advantage of the differences between the first last level cache 118 and the second last level cache 120 when scheduling instructions. In accordance with the described techniques, the first last level cache 118 and the second last level cache 120 are communicably coupled to a respective set of cores. In the illustrated example, for instance, the first last level cache 118 is coupled to the first set of cores 110 and the second last level cache 120 is coupled to the second set of cores 114. In this way, the system 100 is capable of scheduling instructions to the cores of the first set of cores 110 and the cores of the second set of cores 114 based on both the heterogeneity of the core types and also the different characteristics between the first last level cache 118 and the second last level cache 120.

In at least one example configuration of the processing unit 104, for instance, the first set of cores 110 includes a plurality of performance cores (e.g., eight cores), the second set of cores 114 includes a plurality of efficiency cores (e.g., sixteen cores), and the first last level cache 118 to which the first set of cores 110 is coupled is larger (e.g., has more storage capacity) than the second last level cache 120 to which the second set of cores 114 is coupled. As noted above “performance” cores execute instructions at a higher frequency and consume more power than “efficiency” cores. Also, although eight cores and sixteen cores are mentioned in the example above, in variations, the first set of cores 110 and the second set of cores 114 have different numbers of cores.

Although the computing device 102 is depicted as a laptop in the illustrated example. In variations, the computing device 102 may be any of a variety of other types of computing devices, examples of which include but are not limited to, a server computer, a personal computer (e.g., a desktop or tower computer), a smartphone or other wireless phone, a tablet or phablet computer, a notebook computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

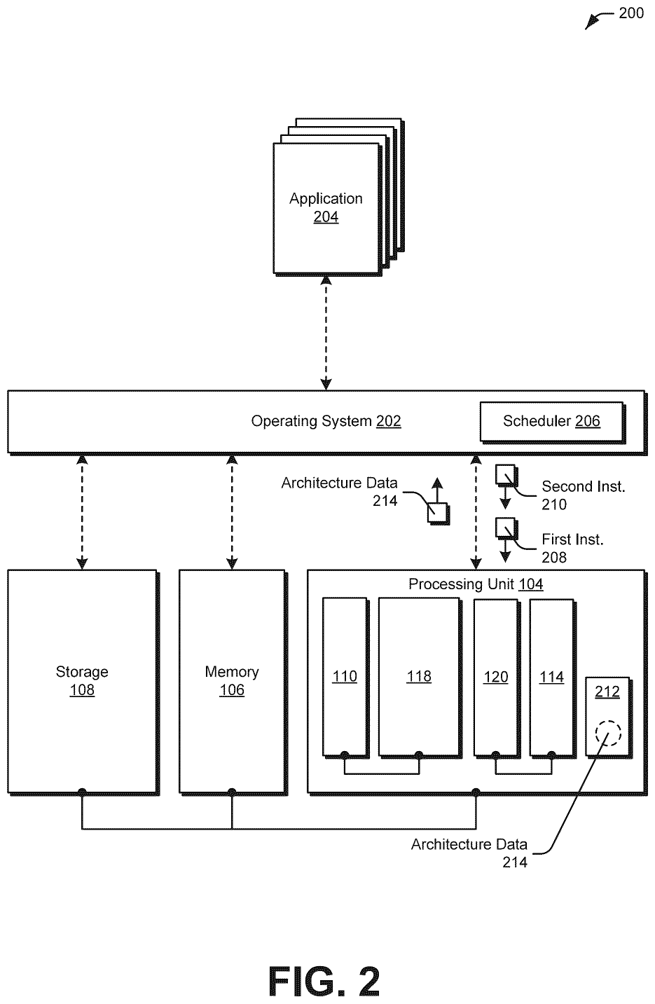

Further, the processing unit 104, the memory 106, the storage 108, and/or any other components of the computing device 102 are connected using any of a variety of wired or wireless connections. Examples of connections which are usable to communicably couple those components include but are not limited to, buses (e.g., a data bus, a system, an address bus), interconnects, memory channels, through silicon vias, traces, and planes. Other example connections include optical connections, fiber optic connections, and/or connections or links based on quantum entanglement. Similarly, the components of the processing unit 104—the first set of cores 110, the second set of cores 114, the first last level cache 118, and the second last level cache 120—are connected using any of a variety of wired or wireless connections. In the context of scheduling tasks on the different types of cores of the processing unit 104 consider the following discussion of FIG. 2.

FIG. 2 is a block diagram of a non-limiting example 200 in which instructions are scheduled to cores based on differing characteristics of cores and caches across both a heterogeneous core architecture and asymmetrical last level cache.

The illustrated example 200 includes the memory 106, the storage 108, and the processing unit 104 having the heterogenous core architecture with the first set of cores 110 and the second set of cores 114 and also having asymmetrical last level cache with the first last level cache 118 and the second last level cache 120. The processing unit 104, the memory 106, and the storage 108 are operable to implement an operating system 202 (one example of an application) and one or more applications 204 which run on top of the operating system 202.

The memory 106 is a device or system that is used to store information, such as for use in a device, e.g., by the processing unit 104. In one or more implementations, the memory 106 corresponds to semiconductor memory where data is stored within memory cells on one or more integrated circuits. In at least one example, the memory 106 corresponds to or includes volatile memory. Alternatively or in addition, the memory 106 corresponds to or includes non-volatile memory. The memory 106 is configurable in a variety of ways that support the use of asymmetrical last level cache by a heterogenous architecture.

Here, the operating system 202 includes a scheduler 206. Whether implemented in software of the operating system 202 as depicted or implemented in hardware of another component of the system 100, the scheduler 206 is configured to schedule the components of the system 100, e.g., the processing unit 104, the memory 106, and the storage 108, to perform different tasks. For example, the scheduler 206 is configured to schedule the cores of the first set of cores 110 and/or the second set of cores 114 to execute one or more instructions, which results in the first set of cores 110 and the second set of cores 114 using the first last level cache 118 and the second last level cache 120, respectively.

In contrast to conventionally configured schedulers, however, the scheduler 206 schedules execution of an instruction on one or more cores based on both the characteristics of the cores included in a set of cores (e.g., performance or efficiency) and the characteristics of the last level cache associated with the set of cores.

In the context of the illustrated example 200, in a first scenario, the scheduler 206 schedules a first instruction 208 for execution on a core of the first set of cores 110 based on characteristics of the cores of the first set of cores 110 and also based on characteristics of the first last level cache 118. In this scenario, the scheduler 206 assigns the first instruction 208 to the first set of cores 110 based on the characteristics of the first set of cores 110 and the first last level cache 118 being better suited for executing the first instruction 208 than the characteristics of the second last level cache 120 and the second set of cores 114. In one or more implementations, the scheduler 206 obtains one or more attributes of the first instruction 208 and maps the one or more attributes to the characteristics of the first set of cores 110 and the first last level cache 118, such as based on a set of deterministic rules, historical outcomes resulting from executing the first instruction 208 or similar instructions, a table or mapping of attributes to characteristics, and/or a prediction by one or more machine learning models, to name just a few.

In a second example scenario, the scheduler 206 schedules a second instruction 210 on a core of the second set of cores 114 based on characteristics of the cores of the second set of cores 114 and also based on characteristics of the second last level cache 120. In this second scenario, the scheduler 206 assigns the second instruction 210 on the second set of cores 114 based on the characteristics of the second set of cores 114 and the second last level cache 120 being better suited for executing the second instruction 210 than the characteristics of the first set of cores 110 and the first last level cache 118. In one or more implementations, the scheduler 206 obtains one or more attributes of the second instruction 210 and maps the one or more attributes to the characteristics of the second set of cores 114 and the second last level cache 120, such as based on a set of deterministic rules, historical outcomes resulting from executing the first instruction 208 or similar instructions, a table or mapping of attributes to characteristics, and/or a prediction by one or more machine learning models, to name just a few. Alternatively, the scheduler 206 schedules the first instruction 208 to the second set of cores 114 based on the core and cache characteristics and schedules the second instruction 210 to the first set of cores 110 based on the core and cache characteristics.

In at least one variation, the scheduler 206 schedules the first instruction 208 and/or the second instruction 210 based in part on availability of cores of the first set of cores 110 and/or the second set of cores 114. For example, if, in one scenario, the scheduler 206 identifies that the first set of cores 110 is better suited for executing the first instruction 208 based on mapping attributes of the first instruction 208 to the characteristics of the first set of cores 110 and the first last level cache 118, and the scheduler 206 also identifies that there will be a delay executing the first instruction 208 on the first set of cores 110 because the first set of cores 110 is already occupied executing other instructions or scheduled to execute them before the first instruction 208, then the scheduler 206 is capable of overriding the mapping to schedule the first instruction 208 instead on the second set of cores 114, e.g., if they are empty and/or available. As a result, the first instruction 208 can be performed sooner than if scheduled on occupied cores and/or cores with a longer queue of already scheduled instructions. In one or more implementations, the first instruction 208 and the second instruction 210 are associated with one or more of the applications 204. Thus, the scheduler 206 is capable of scheduling the first instruction 208 and the second instruction 210 in connection with executing those one or more applications 204.

In the illustrated example 200, the processing unit 104 also includes storage 212, which is configured to maintain architecture data 214. The architecture data 214 describes the heterogeneous architecture of the processing unit 104′s cores and also the asymmetrical last level cache, e.g., how much and type of last level cache accessible to each core of the first set of cores 110 and how much cache and type of last level cache accessible to each core of the second set of cores 114. This system-level description is paramount because, unlike conventional techniques, the available cache for a single core of the system 100 cannot simply be multiplied by the integer number of cores of the system 100 to obtain the amount of cache of the system, i.e., because the cores have different amounts of accessible cache since the first last level cache 118 and the second last level cache 120 are asymmetrical.

The storage 212 is configurable in various ways to store the architecture data 214, examples of which include but are not limited to one or more registers, static random-access memory (SRAM), and/or flash memory, to name just a few.

By scheduling instructions across an heterogenous architecture and an asymmetrical last level cache, the scheduler 206 and thus the system 100 optimize the throughput (e.g., number of instructions executed by the cores) relative to amount of power used by the system 100 to execute those instructions. In other words, for a heterogenous workload, per unit of power, the system 100 is capable of performing more instructions than conventional systems. Said another way, for a heterogenous workload, per instruction executed the system 100, is capable of using less power than conventional systems. In addition to reducing an amount of power used for mere execution of instructions, this architecture also provides thermal benefits. By using less power for mere execution, for instance, the system 100 heats up less than if the system utilized more power. By extension, the system 100 may also utilize less cooling (e.g., fans or fluid pumps), reducing an amount of power used even further.

FIG. 3 is a block diagram of a non-limiting example 300 that includes a cache hierarchy with asymmetrical last level cache.

The example 300 depicts the processing unit 104, which includes the first set of cores 110, the second set of cores 114, the first last level cache 118, and the second last level cache 120. The example 300 also depicts various caches at different levels of a cache hierarchy.

For example, each core 112 of the first set of cores 110 and each core of the at least one core 116 is depicted having an L0/L1 cache 302. In this example, the L0/L1 caches 302 of the cores corresponds to a highest level or levels of the cache, e.g., a “first” level of the cache hierarchy. In this example 300, the processing unit 104 also includes a plurality L2 caches 304. Here, the example 300 includes an L2 cache 304 for each core 112, 116. Thus, in this example, each core 112, 116 is associated with (e.g., communicatively coupled to) a respective L2 cache. The L2 caches 304 correspond to a lower level (e.g., a next lower level) of the cache hierarchy than the L0/L1 caches 302, e.g., the “second” level of the cache hierarchy.

The illustrated example 300 also includes a first L3 cache 306 and a second L3 cache 308. In accordance with the described techniques, the first L3 cache 306 and the second L3 cache 308 are asymmetrical, such as due to one or more differences in any of the cache characteristics mentioned above. In this example, the first L3 cache 306 is associated with (e.g., communicatively coupled to) the first set of cores 110 and the second L3 cache 308 is associated with (e.g., communicatively coupled to) the second set of cores 114. In this way, each individual core 112 of the first set of cores 110 shares the first L3 cache 306 with each other core 112 of the first set of cores 110—but not with any core 116 of the second set of cores 114. Similarly, each individual core 116 of the second set of cores 114 shares the second L3 cache 308 with each other core 116 of the second set of cores 114—but not with any core 112 of the first set of cores 110. In this example, the first L3 cache 306 and the second L3 cache 308 correspond to a lowest or “last” level of the cache hierarchy. Although three levels of a cache hierarchy are discussed, in at least one variation, the described techniques are implemented in a system having a different number of cache levels, e.g., two levels or four levels. Regardless of a number of levels in the cache hierarchy, at least one level of the cache (e.g., the last level) is separated and is asymmetrical between at least two sets of cores, such that at least one set of cores is associated with a last level cache that is asymmetrical with the last level cache associated with at least one other set of cores.

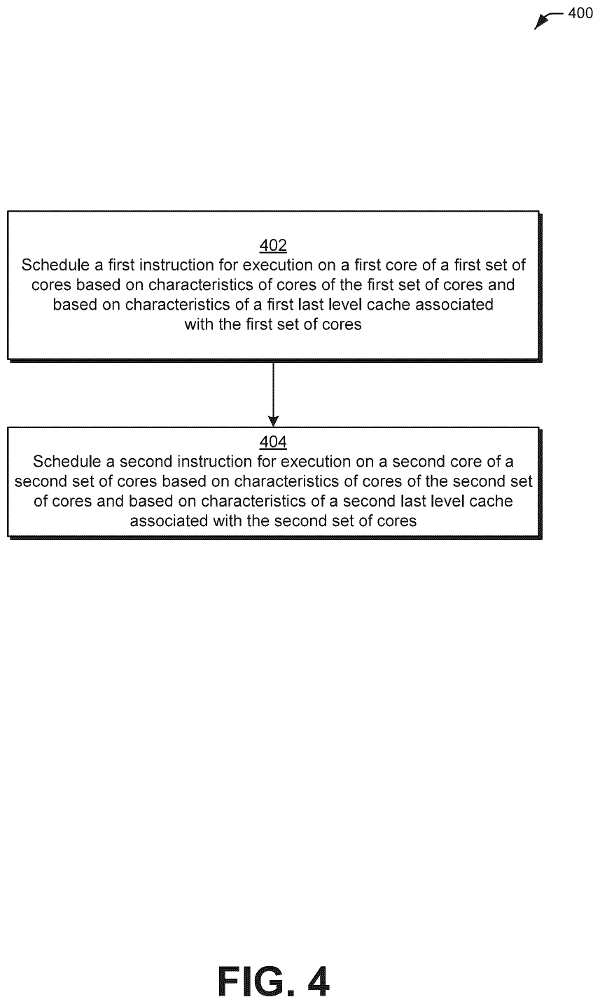

FIG. 4 depicts a non-limiting example procedure 400 for asymmetrical last level caches.

A first instruction for execution on a first core of a first set of cores is scheduled based on characteristics of cores of the first set of cores and based on characteristics of a first last level cache associated with the first set of cores (block 402). By way of example, the scheduler 206 schedules a first instruction 208 for execution on a first core 112 of a first set of cores 110 based on characteristics of the first set of cores 110 and based on characteristics of the first last level cache 118 associated with the first set of cores 110. In one or more implementations, the scheduler 206 determines the characteristics of the first instruction by analyzing the computational requirements of the instruction, its expected latency, power consumption implications, and/or the potential for cache hits or misses. Based on this analysis, the scheduler 206 identifies a first core within a first set of cores that is optimized for executing the first instruction. This decision is made considering both the performance characteristics of the first core and the characteristics of a first last level cache associated with the first set of cores. For instance, if the first instruction is performance-critical and likely to benefit from rapid data access, the scheduler may allocate it to a high-performance core associated with a larger first last level cache.

A second instruction for execution on a second core of a second set of cores is scheduled based on characteristics of cores of the second set of cores and based on characteristics of a second last level cache associated with the second set of cores (block 404). By way of example, the scheduler 206 schedules a second instruction 210 for execution on a second core 116 of a second set of cores 114 based on characteristics of the second set of cores 114 and based on characteristics of the second last level cache 120 associated with the second set of cores 114. In one or more implementations, the scheduler 206 determines the characteristics of the second instruction and identifies a second core within a second set of cores that is optimized for executing the second instruction. This decision is also based on the performance characteristics of the second core and the characteristics of a second last level cache associated with the second set of cores. If the second instruction is less demanding and suitable for energy-efficient processing, the scheduler may allocate it to an efficiency core associated with a smaller second last level cache. In this way, the scheduler dynamically allocates tasks to various cores based on a combination of the performance characteristics of the cores and the attributes of their associated last level caches. This approach is advantageous because the last level caches are asymmetrical, meaning they have differing characteristics such as size, speed, placement policy, replacement policy, or associativity. This allows the system to optimize both performance and energy efficiency, adapting to the specific requirements of each instruction.

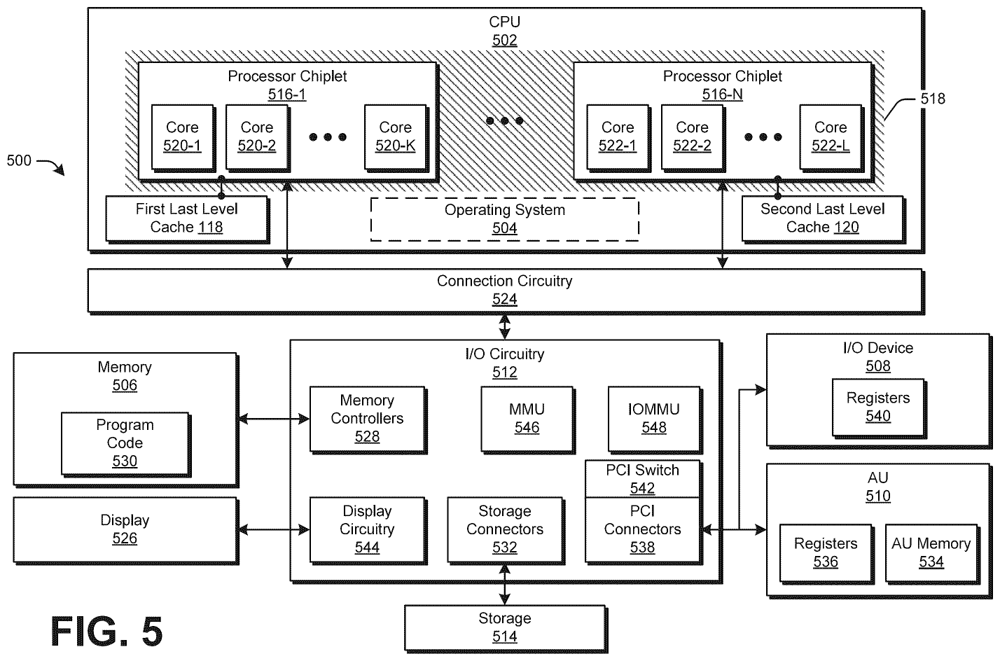

FIG. 5 is a block diagram of a processing system 500 configured to execute one or more applications, in accordance with one or more implementations.

FIG. 5 includes a processing system 500 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 500 includes a central processing unit (CPU) 502. In one or more implementations, the CPU 502 is configured to run an operating system (OS) 504 that manages the execution of applications. For example, the OS 504 is configured to schedule the execution of tasks (e.g., instructions) for applications, allocate portions of resources (e.g., system memory 506, CPU 502, input/output (I/O) device 508, accelerator unit (AU) 510, storage 514) for the execution of tasks for the applications, provide an interface to I/O devices (e.g., I/O device 508) for the applications, or any combination thereof.

In this example, the first last level cache 118 and the second last level cache 120 are depicted in the CPU 502. In variations, however, the first last level cache 118 and the second last level cache 120 are included in and/or is implemented by one or more different components of the processing system 500, such as the memory 506, the I/O device 508, the AU 510, the I/O circuitry 512, the storage 514, and so forth.

The CPU 502 includes one or more processor chiplets 516, which are communicatively coupled together by a data fabric 518 in one or more implementations.

Each of the processor chiplets 516, for example, includes one or more processor cores 520, 522 configured to concurrently execute one or more series of instructions, also referred to herein as “threads,” for an application. Further, the data fabric 518 communicatively couples each processor chiplet 516-N of the CPU 502 such that each processor core (e.g., processor cores 520) of a first processor chiplet (e.g., 516-1) is communicatively coupled to each processor core (e.g., processor cores 522) of one or more other processor chiplets 516. Though the example embodiment presented in FIG. 5 shows a first processor chiplet (516-1) having three processor cores (520-1, 520-2, 520-K) representing a K number of processor cores 522 and a second processor chiplet (516-N) having three processor cores (e.g., 522-1, 522-2, 522-L) representing an L number of processor cores 522, in other implementations (L being an integer number greater than or equal to one), each processor chiplet 516 may have any number of processor cores 520, 522. For example, each processor chiplet 516 can have the same number of processor cores 520, 522 as one or more other processor chiplets 516, a different number of processor cores 520, 522 as one or more other processor chiplets 516, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 500, the CPU 502 is communicatively coupled to an I/O circuitry 512 by a connection circuitry 524. For example, each processor chiplet 516 of the CPU 502 is communicatively coupled to the I/O circuitry 512 by the connection circuitry 524. The connection circuitry 524 includes, for example, one or more data fabrics, buses, buffers, queues, and the like. The I/O circuitry 512 is configured to facilitate communications between two or more components of the processing system 500 such as between the CPU 502, system memory 506, display 526, universal serial bus (USB) devices, peripheral component interconnect (PCI) devices (e.g., I/O device 508, AU 510), storage 514, and the like.

As an example, system memory 506 includes any combination of one or more volatile memories and/or one or more non-volatile memories, examples of which include dynamic random-access memory (DRAM), static random-access memory (SRAM), non-volatile RAM, and the like. To manage access to the system memory 506 by CPU 502, the I/O device 508, the AU 510, and/or any other components, the I/O circuitry 512 includes one or more memory controllers 528. These memory controllers 528, for example, include circuitry configured to manage and fulfill memory access requests issued from the CPU 502, the I/O device 508, the AU 510, or any combination thereof. Examples of such requests include read requests, write requests, fetch requests, pre-fetch requests, or any combination thereof. That is to say, these memory controllers 528 are configured to manage access to the data stored at one or more memory addresses within the system memory 506, such as by CPU 502, the I/O device 508, and/or the AU 510.

When an application is to be executed by processing system 500, the OS 504 running on the CPU 502 is configured to load at least a portion of program code 530 (e.g., an executable file) associated with the application from, for example, a storage 514 into system memory 506. This storage 514, for example, includes a non-volatile storage such as a flash memory, solid-state memory, hard disk, optical disc, or the like configured to store program code 530 for one or more applications.

To facilitate communication between the storage 514 and other components of processing system 500, the I/O circuitry 512 includes one or more storage connectors 532 (e.g., universal serial bus (USB) connectors, serial AT attachment (SATA) connectors, PCI Express (PCIe) connectors) configured to communicatively couple storage 514 to the I/O circuitry 512 such that I/O circuitry 512 is capable of routing signals to and from the storage 514 to one or more other components of the processing system 500.

In association with executing an application, in one or more scenarios, the CPU 502 is configured to issue one or more instructions (e.g., threads) to be executed for an application to the AU 510. The AU 510 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 510 includes one or more compute units that concurrently execute one or more threads of an application and store data resulting from the execution of these threads in AU memory 534. This AU memory 534, for example, includes any combination of one or more volatile memories and/or non-volatile memories, examples of which include caches, video RAM (VRAM), or the like. In one or more implementations, these compute units are also configured to execute these threads based on the data stored in one or more physical registers 536 of the AU 510.

To facilitate communication between the AU 510 and one or more other components of processing system 500, the I/O circuitry 512 includes or is otherwise connected to one or more connectors, such as PCI connectors 538 (e.g., PCle connectors) each including circuitry configured to communicatively couple the AU 510 to the I/O circuitry such that the I/O circuitry 512 is capable of routing signals to and from the AU 510 to one or more other components of the processing system 500. Further, the PCle connectors 538 are configured to communicatively couple the I/O device 508 to the I/O circuitry 512 such that the I/O circuitry 512 is capable of routing signals to and from the I/O device 508 to one or more other components of the processing system 500.

By way of example and not limitation, the I/O device 508 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 508 is configured to execute one or more operations, tasks, instructions, or any combination thereof based on one or more physical registers 540 of the I/O device 508. In one or more implementations, such physical registers 540 are configured to maintain data (e.g., operands, instructions, values, variables) indicating one or more operations, tasks, or instructions to be performed by the I/O device 508.

To manage communication between components of the processing system 500 (e.g., AU 510, I/O device 508) that are connected to PCI connectors 538, and one or more other components of the processing system 500, the I/O circuitry 512 includes PCI switch 542. The PCI switch 542, for example, includes circuitry configured to route packets to and from the components of the processing system 500 connected to the PCI connectors 538 as well as to the other components of the processing system 500. As an example, based on address data indicated in a packet received from a first component (e.g., CPU 502), the PCI switch 542 routes the packet to a corresponding component (e.g., AU 510) connected to the PCI connectors 538.

Based on the processing system 500 executing a graphics application, for instance, the CPU 502, the AU 510, or both are configured to execute one or more instructions (e.g., draw calls) such that a scene including one or more graphics objects is rendered. After rendering such a scene, the processing system 500 stores the scene in the storage 514, displays the scene on the display 526, or both. The display 526, for example, includes a cathode-ray tube (CRT) display, liquid crystal display (LCD), light emitting diode (LED) display, organic light emitting diode (OLED) display, or any combination thereof. To enable the processing system 500 to display a scene on the display 526, the I/O circuitry 512 includes display circuitry 544. The display circuitry 544, for example, includes high-definition multimedia interface (HDMI) connectors, DisplayPort connectors, digital visual interface (DVI) connectors, USB connectors, and the like, each including circuitry configured to communicatively couple the display 526 to the I/O circuitry 512. Additionally or alternatively, the display circuitry 544 includes circuitry configured to manage the display of one or more scenes on the display 526 such as display controllers, buffers, memory, or any combination thereof.

Further, the CPU 502, the AU 510, or both are configured to concurrently run one or more virtual machines (VMs), which are each configured to execute one or more corresponding applications. To manage communications between such VMs and the underlying resources of the processing system 500, such as any one or more components of processing system 500, including the CPU 502, the I/O device 508, the AU 510, and the system memory 506, the I/O circuitry 512 includes memory management unit (MMU) 546 and input-output memory management unit (IOMMU) 548. The MMU 546 includes, for example, circuitry configured to manage memory requests, such as from the CPU 502 to the system memory 506. For example, the MMU 546 is configured to handle memory requests issued from the CPU 502 and associated with a VM running on the CPU 502. These memory requests, for example, request access to read, write, fetch, or pre-fetch data residing at one or more virtual addresses (e.g., guest virtual addresses) each indicating one or more portions (e.g., physical memory addresses) of the system memory 506. Based on receiving a memory request from the CPU 502, the MMU 546 is configured to translate the virtual address indicated in the memory request to a physical address in the system memory 506 and to fulfill the request. The IOMMU 548 includes, for example, circuitry configured to manage memory requests (memory-mapped I/O (MMIO) requests) from the CPU 502 to the I/O device 508, the AU 510, or both, and to manage memory requests (direct memory access (DMA) requests) from the I/O device 508 or the AU 510 to the system memory 506. For example, to access the registers 540 of the I/O device 508, the registers 536 of the AU 510, and/or the AU memory 534, the CPU 502 issues one or more MMIO requests. Such MMIO requests each request access to read, write, fetch, or pre-fetch data residing at one or more virtual addresses (e.g., guest virtual addresses) which each represent at least a portion of the registers 540 of the I/O device 508, the registers 536 of the AU 510, or the AU memory 534, respectively. As another example, to access the system memory 506 without using the CPU 502, the I/O device 508, the AU 510, or both are configured to issue one or more DMA requests. Such DMA requests each request access to read, write, fetch, or pre-fetch data residing at one or more virtual addresses (e.g., device virtual addresses) which each represent at least a portion of the system memory 506. Based on receiving an MMIO request or DMA request, the IOMMU 548 is configured to translate the virtual address indicated in the MMIO or DMA request to a physical address and fulfill the request.

In variations, the processing system 500 can include any combination of the components depicted and described. For example, in at least one variation, the processing system 500 does not include one or more of the components depicted and described in relation to FIG. 5. Additionally or alternatively, in at least one variation, the processing system 500 includes additional and/or different components from those depicted. The 500 is configurable in a variety of ways with different combinations of components in accordance with the described techniques.

1. A computing device comprising:
a first set of cores;
a first last level cache associated with the first set of cores;
a second set of cores that are heterogeneous from the first set of cores; and
a second last level cache associated with the second set of cores.

2. The computing device of claim 1, wherein the first last level cache and the second last level cache are asymmetrical.

3. The computing device of claim 1, wherein the first set of cores comprise a first core type and the second set of cores comprise a second core type.

4. The computing device of claim 3, wherein the first set of cores of the first core type have at least one performance characteristic that is different than the second set of cores of the second core type.

5. The computing device of claim 3, wherein the first set of cores of the first core type comprise high performance cores and the second set of cores of the second core type comprise efficiency cores.

6. The computing device of claim 5, wherein the first last level cache is larger than the second last level cache.

7. The computing device of claim 1, further comprising an operating system and a memory controller, the memory controller configured to assign instructions requested by the operating system to either the first set of cores associated with the first last level cache or the second set of cores associated with the second last level cache.

8. The computing device of claim 7, wherein the memory controller is configured to assign instructions based on both performance characteristics of the first set of cores and the second set of cores and sizes of the first last level cache and the second last level cache.

9. The computing device of claim 1, wherein the computing device comprises a laptop, and wherein the first set of cores and the second set of cores are included in a central processing unit of the laptop.

10. A system comprising:
a central processing unit comprising at least a first core and a second core, wherein the first core and the second core are heterogeneous; and
at least two asymmetrical last level caches.

11. (canceled)

12. The system of claim 10, wherein the first core comprises a high performance core and the second core comprises an efficiency core.

13. The system of claim 12, wherein the at least two asymmetrical last level caches include at least a first last level cache and a second last level cache.

14. The system of claim 13, wherein the first last level cache is associated with the high performance core and the second last level cache is associated with the efficiency core.

15. The system of claim 14, wherein the first last level cache is larger than the second last level cache.

16. The system of claim 13, wherein the at least two asymmetrical last level caches include at least a third last level cache.

17. The system of claim 16, further comprising a third core that is associated with the third last level cache.

18. The system of claim 17, wherein the third core comprises a low priority core.

19. A method comprising:
scheduling a first instruction for execution on a first core of a first set of cores based on characteristics of cores of the first set of cores and based on characteristics of a first last level cache associated with the first set of cores; and
scheduling a second instruction for execution on a second core of a second set of cores based on characteristics of cores of the second set of cores and based on characteristics of a second last level cache associated with the second set of cores.

20. The method of claim 19, wherein the first core comprises a high performance core and the second core comprises an efficiency core, and wherein the first last level cache is larger than the second last level cache.

21. The system of claim 14, wherein the high performance core operates at a higher frequency than the efficiency core.
